(19) United States
(12) Patent Application Publication
(10) Pub. No.: US 2012/0320995 A1
(43) Pub. Date: Dec. 20, 2012

(54) CO-EXISTENCE OF MULTI-CARRIER AND SINGLE CARRIER COMMUNICATION STANDARDS ON SHARED PLC CHANNEL

(75) Inventors: ANAND G. DABAK, PLANO, TX (US); TARKESH PANDE, DALLAS, TX (US); RAMANUJA VEDANTHAM, ALLEN, TX (US)

(73) Assignee: TEXAS INSTRUMENTS INCORPORATED, Dallas, TX (US)

(21) Appl. No.: 13/489,163

(22) Filed: Jun. 5, 2012

Related U.S. Application Data
(60) Provisional application No. 61/498,304, filed on Jun. 17, 2011.

(51) Int. Cl. H04B 15/00; H04B 3/46

(52) U.S. Cl. 375/257

(57) ABSTRACT

A method for reducing interference on a shared powerline communications (PLC) channel in a PLC network including a first node using a multi-carrier modulation communication standard operating at a first and second carrier frequency and a second node using a single-carrier modulation communication standard operating based on a single-carrier frequency. (i) Non-overlapping transmission times are determined for transmissions by the first node relative to second node transmission times for transmissions from the second node or (ii) non-overlapping frequencies are selected for the first carrier frequency and second carrier frequency which do not overlap with the single-carrier frequency or frequencies based on the single-carrier frequency. The second node transmits using the single-carrier modulation communication standard at the second node transmission times. The first node transmits using the multi-carrier modulation communication standard at the non-overlapping transmission times or non-overlapping frequencies.

### CROSS REFERENCE TO RELATED APPLICATIONS

This application and the subject matter disclosed herein claims the benefit of Provisional Application Ser. No. 61/498,304 entitled “Co-existence of OFDM with FSK for PLC Communication” filed Jun. 17, 2011, which is herein incorporated by reference in its entirety.

### FIELD

Disclosed embodiments relate generally to the field of powerline communications.

### BACKGROUND

Current and next generation narrow band powerline communications (PLC) is likely to be mostly Orthogonal Frequency-Division Multiplexing (OFDM)-based in order to obtain higher network throughput. OFDM is a digital multi-carrier modulation method where a large number of closely spaced orthogonal sub-carrier signals are used to transmit the data. Examples of OFDM-based PLC standards include IEEE P1901.2 and PoweRline Intelligent Metering Evolution (PRIME).

Legacy communication systems also exist which use simpler single-carrier modulation schemes which involve only a single-carrier frequency, such as binary phase shift keying (BPSK), and Frequency-shift keying (FSK) such as S-FSK(G1). FSK utilizes a frequency modulation scheme in which digital information is transmitted through discrete frequency changes of a single-carrier wave. The simplest FSK is binary FSK (BFSK) where the modulated signal includes two frequencies. Phase-shift keying (PSK) is another single-carrier modulation scheme that conveys data by modulating the phase of the carrier wave (sometimes referred to as BPSK).

The frequency bands in which OFDM modulation for PLC applications are to be deployed is scheduled to be the same as those of the legacy modulation solutions based on single-carrier modulation. For example, the Lonworks CEA 709.1 PLC solution uses dual-carrier frequency modulation which can operate either in the CENELEC-A band or CENELEC-BC band. When deployed in the CENELEC-A band the two channels that are supported are centered at 75 kHz and 86 kHz, while when deployed in the CENELEC BC band the two channels supported are centered at 115 kHz and 132 kHz, respectively. CEA 709.2 is another example of a PLC specification where data is transmitted using single-carrier modulation (BPSK) in a channel centered at 132 kHz, and thus may be affected by the out of band signal level for the OFDM signal in the FCC-band (154 kHz to 487.5 kHz)

### SUMMARY

Disclosed embodiments recognize interference may result on a shared powerline communications (PLC) channel in a PLC network where at least one node employs a single-carrier modulation communication standard and at least one node employs a multi-carrier modulation communication standard when there is overlapping frequency bands, or where the frequencies are close enough so that out of band-emission interference may result. Disclosed embodiments include time domain and frequency domain-based solutions which allow the co-existence of single-carrier modulation-based and multi-carrier modulation communication standards on a shared PLC channel. In one particular embodiment the single-carrier modulation comprises frequency-shift keying (FSK) or binary phase-shift keying (BPSK) and the multi-carrier modulation comprises Orthogonal Frequency-Division Multiplexing (OFDM).

### BRIEF DESCRIPTION OF THE DRAWINGS

Reference will now be made to the accompanying drawings, which are not necessarily drawn to scale, wherein:

FIG. 1 is a block diagram illustration of an example energy detection and analysis system (EDAS) that implements a method for determining the presence of a single-carrier modulated transmission (e.g., FSK or BPSK) on a shared PLC channel, according to an example embodiment.

FIG. 2 is a block diagram illustration of an another example EDAS having band pass filter that implements a method for determining the presence of single-carrier modulated transmission (e.g., FSK or BPSK) on a shared PLC channel.

FIG. 3 is a block diagram schematic of a communication device having a disclosed modem that implements operation on a shared PLC communication channel having a first communications standard that uses single-carrier modulation and second communication standard signals that uses multi-carrier modulation using a disclosed coexistence of communication standards algorithm, according to an example embodiment.

FIG. 4 is a flowchart for an example method for reducing interference on a shared PLC channel in a PLC network that allows the co-existence of a single-carrier modulation standard and a multi-carrier modulation standard, according to an example embodiment.

### DETAILED DESCRIPTION

Disclosed embodiments now will be described more fully hereinafter with reference to the accompanying drawings. Such embodiments may, however, be embodied in many different forms and should not be construed as limited to the embodiments set forth herein. Rather, these embodiments are provided so that this disclosure will be thorough and complete, and will fully convey the scope of this disclosure to those having ordinary skill in the art. One having ordinary skill in the art may be able to use the various disclosed embodiments and there equivalents. As used herein, the term “couple” or “couples” is intended to mean either an indirect or direct electrical connection, while “communicably coupled” includes both electrical and wireless connections. Thus, if a first device couples to a second device, that connection may be through a direct electrical connection, or through an indirect electrical connection via other devices and connections.

One disclosed embodiment involves Time Domain Duplexing (TDD)-based solutions that allow coexistence on a shared PLC channel of a PLC network of a single-carrier modulation communication standard and a multi-carrier modulation communication standard that have overlapping frequency bands, or where the frequencies are close enough so that out of band-emission interference may result. Although the multi-carrier modulation communication standard is generally described as being based on OFDM, other multi-carrier modulation standards for PLC exist, such as IEEE P1901 which supports HD-PLC or wavelet modulation.

Disclosed TDD solutions involve allowing only one of the modulation techniques (selected from multi-carrier modulation and single-carrier modulation) to use the shared PLC channel at any given time. Signals from nodes operating using either multi-carrier modulation or single-carrier based modulation can be detected and analyzed to determine whether the shared PLC channel is in use by a node operating using the other modulation technology. An example method by which FSK or BPSK modulation may be determined to be on a shared PLC channel to allow co-existence with OFDM-based modulation is now described.

This embodiment recognizes the presence of single-carrier based modulated signals may be detected by the measurement and analysis of signal energy from such signals. One example of single-carrier modulation is FSK. FSK is a modulation scheme where the presence of a tone at a certain frequency indicates the presence of a message bit. In binary FSK, there are two discrete frequencies, where the presence of one frequency indicates a mark frequency or bit 1, while the presence of the second frequency indicates a space frequency or 0 bit is being transmitted. This embodiment recognizes if the respective frequencies for FSK are known then a suitable energy detector can measure the energy around one or both of the discrete frequencies with an appropriate energy threshold, to indicate whether the single-carrier based modulation is currently being transmitted on the shared PLC channel.

In BPSK the modulation data is transmitted around one center frequency. The presence of bit 0 or bit 1 is indicated by two different amplitude levels. When BPSK transmission is used, its presence can be detected by measuring the energy around the center frequency of transmission. In conventional PLC systems it is known that legacy BPSK solutions are deployed in the CENELEC A or CENELEC B/C band.

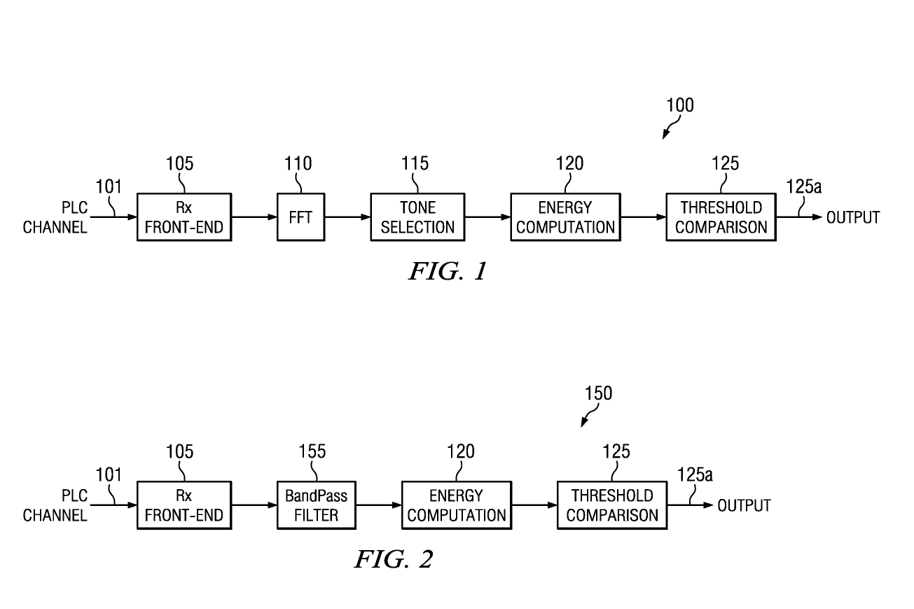

FIG. 1 is a block diagram illustration of an example energy detection and analysis system (EDAS) 100 that implements a method for determining the presence of a single-carrier modulation-based transmission on a shared PLC channel 101, such as FSK or BPSK. A receiver (Rx) front-end block 105 receives and digitizes the incoming signal from the PLC channel 101 shown. A fast Fourier transform (FFT) block 110 performs a FFT on the digitized incoming signal to compute the discrete Fourier transform (DFT) which decomposes a sequence of values into components of different frequencies. A tone (frequency) selection block 115 provides selection (filtering) of tones around the discrete frequencies corresponding to the single-carrier modulation-based transmission. Energy computation block 120 provides an energy level computation for the discrete frequencies.

Threshold comparison block 125 determines if the energy level of at least one of the discrete frequencies for FSK or the center frequency for BPSK exceeds the predetermined energy threshold(s), and if so, the output 125a of the threshold comparison block 125 reflects the presence of single-carrier modulation on the PLC channel 101. The energy threshold(s) can be chosen to target a probability of detection or probability of a false alarm for a given received signal power to noise power ratio. The probability of detection versus threshold for different signal to noise power ratios can be computed offline for Gaussian noise channels and stored as look-up tables Likewise, the probability of false alarm versus threshold for different signal to noise power ratio's can be computed offline for Gaussian noise channels and stored as look-up tables. The time duration for energy computation provided by the energy computation block 120 may correspond to the symbol period of the single-carrier modulation-based transmission, or multiples thereof.

FIG. 2 is a block diagram illustration of an another example EDAS 150 having a band pass filter for tone selection that implements a method for determining the presence of a single-carrier modulation-based transmission on a shared PLC channel. Rx front-end block 105 receives and digitizes the incoming signal from the PLC channel 101 as shown. The digitized signal is then passed through a band-pass filter block 155 to energy computation block 120, and then to threshold comparison block 125 having output 125a.

The band pass filter block 155 can be implemented either using analog circuitry or digital circuitry to provide narrow passband(s) around the single-carrier based modulation frequency(ies). As noted above, energy computation block 120 provides an energy level computation for one or more discrete frequencies and the threshold comparison block 125 determines if the computed energy level(s) exceeds their threshold(s), and if so, the presence of single-carrier modulation on the PLC channel may be determined. Several variants of this scheme are possible. One variant comprises if the presence of single-carrier modulation is detected and the single-carrier modulation is FSK, then the total energy for both of the frequencies are added before comparing to a threshold. If the total energy exceeds the threshold, then FSK transmission can be determined to be present on the PLC channel 101.

Another variant comprises if the presence of single-carrier modulation is detected and the single-carrier modulation is FSK, then the energy output of both frequencies are separately compared to a threshold, and only if both energies exceed their respective thresholds is FSK determined to be present on the PLC channel 101. In some embodiments the respective thresholds for the respective frequencies may be different. Different thresholds may be helpful when the background noise is not white so that the noise is frequency shaped. In addition, in some embodiments, the energy threshold(s) may be adaptively computed by estimating the background noise for the frequency band of interest, and then updating the estimate as the background noise level changes.

One method to estimate the background noise is as follows. Long term energy averaging of the frequencies on either side of the frequency band of interest where single-carrier modulation transmission is expected is performed. Based on these measurements, the background noise in the frequency band of interest is estimated where single-carrier modulation transmission is expected. One such estimate can comprise averaging the two energy estimates on either side of the band of interest. The energy threshold may be adjusted based on the amount of background noise in order to generate the desired probability of detection and of a false alarm.

In another embodiment the energy threshold to be used for detecting the presence of single-carrier modulations can also change over time as the noise profile observed in the powerline changes over time. As an example, during noon and evening times, electricity usage in households is generally at a maximum, thus resulting in more loads being present in the powerline at these times. The presence of more loads results in an increase in the noise on the powerline and hence a higher a threshold can be used to reliably detect the presence of single-carrier modulations. The time dependant thresholds might be pre-computed or progressively “learned” over time.

Using either EDAS 100 or 150 at a PLC node employing multi-carrier modulation, if it is determined that single-carrier modulation is being transmitted on the PLC channel 101, the node can refrain from transmitting during such period of times on the PLC channel 101. The multi-carrier modulation node can wait until the PLC channel is clear of the single-carrier modulation signals before beginning a transmission. This may be done by either continuously monitoring the channel using EDAS 100 or 150, or by waiting for a predetermined time before again using EDAS 100 or 150 to recheck for the presence of single-carrier modulation being on the PLC channel 101.

Another embodiment comprises frequency domain-based solutions. IEEE 1901.2 is an OFDM-based PLC standard that allows for the use of a tone mask in the 10 kHz to 490 kHz frequency band. A tone mask is generally implemented by software which provides predefined (static) system-wide parameter defining the start, stop and notch frequencies. This embodiment recognizes if it is known during deployment time of the PLC network that certain nodes exist in the network that employ single-carrier modulation, and the discrete frequency(ies) used for the single-carrier modulation scheme employed is (are) known, the multi-carrier modulation-based node(s) may operate at frequencies provided by tone masks (i.e., a specific group of subcarriers for transmission) corresponding to frequencies where single-carrier modulation transmissions are not present.

Alternatively if it is not known at PLC system deployment time that single-carrier modulation devices are present at one or more nodes in the network, the multi-carrier modulation-based devices may begin to transmit on the full band-plan as a default mode. Once it is determined that single-carrier transmission devices are present in the network, such as based on the energy detection and analysis methods described above, the subcarriers which fall in the single-carrier transmission band plan can be avoided or intentionally notched at the transmitter, with no information bits transmitted by the multi-carrier modulation-based devices on those subcarriers.

In some embodiments the single-carrier frequency(ies) may not be the same as the frequencies in the multi-carrier modulation frequency band plan. As an example, IEEE P1901.2 allows for OFDM transmission in the FCC band from 154 kHz to 487.5 kHz. CEA-709.2 devices transmit using BPSK in the CENELEC C band-plan at a center frequency of 132 kHz. Hence, although these two devices can potentially co-exist at the same time on a shared powerline, out of band-emissions from the P1901.2 device may cause a degradation in performance of the CEA-709.2 device.

One way to prevent such degradation is as follows. Once the OFDM based device determines that at least one CEA-709.2 device exists in the PLC network, the OFDM based device can incorporate a high pass filter or notch filter in its transmit chain so that the out of band emissions in the CENELEC-C band are minimized, thus allowing both CEA 709.2 devices and OFDM based devices to transmit on a shared PLC channel at the same time without an unacceptable degradation in performance.

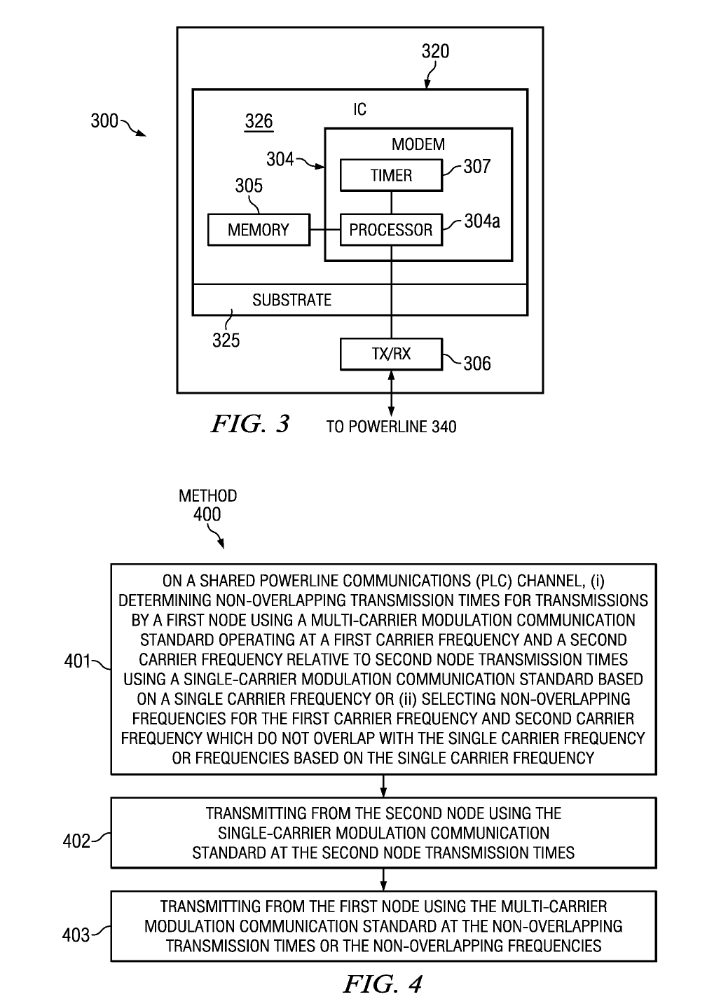

FIG. 3 is a block diagram schematic of a communication device 300 having a disclosed modem 304 that implements operation at a node on a shared PLC communication channel in a PLC network having a node(s) utilizing a single-carrier modulation communications standard and a node(s) utilizing a multi-carrier modulation communication standard, according to an example embodiment. The multi-carrier modulation communication standard operates at a first carrier frequency and a second carrier frequency and the single-carrier modulation communication standard operates at a single-carrier frequency.

Communications device 300 compromises a modem 304 including a processor (e.g., a digital signal processor, (DSP)) 304a coupled to an associated memory 305 that that stores a disclosed coexistence of communication standards algorithm. Communications device 300 can be used at a service node (which includes switch nodes and terminal nodes) or a base (data concentrator) node in the PLC communications network. Memory 305 can comprise static random-access memory (SRAM), for example. The processor 304a is programmed to implement the coexistence of communication standards algorithm. Modem 304 includes a timer 307, such as for setting disclosed non-overlapping communication times.

The Rx front-end block 105 of a disclosed EDAS is provided by the transceiver (TX/RX) 306 that is communicably coupled to the modem 304 which comprises an analog front-end (AFE) that provides a PLC transceiver for coupling of the communications device 300 to the shared powerline 340. Transceiver 306 facilitates communications with other SNs and the BN on the powerline 340, while the remaining blocks of the EDAS can be implemented by processor 304a.

Processor 304a may also implement a tone mask to provide disclosed frequency domain-based solutions. As described above, if it is known during deployment time of the PLC network that certain nodes exist in the network that employ single-carrier modulation, and the discrete frequency(ies) used for the single-carrier modulation scheme employed is (are) known, processor 304a can allow the multi-carrier modulation-based node to operate at frequencies provided by the tone mask (i.e., a specific group of subcarriers for transmission) corresponding to frequencies where single-carrier modulation transmissions are not present.

The modem 304 is shown formed on an integrated circuit (IC) 320 comprising a substrate 325 having a semiconductor surface 326, such as a silicon surface. In another embodiment the modem 304 is implemented using 2 processor chips, such as 2 DSP chips. Besides the DSP noted above, the processor 304a can comprise a desktop computer, laptop computer, cellular phone, smart phone, or an application specific integrated circuit (ASIC).

Disclosed modems 304 and disclosed communications devices 300 can be used in a PLC network to provide a networked device that in service is connected to a powerline via a power cord. In general, the “networked device” can be any equipment that is capable of transmitting and/or receiving information over a powerline. Examples of different types of networked devices include, but are not limited or restricted to a computer, a router, an access point (AP), a wireless meter, a networked appliance, an adapter, or any device supporting connectivity to a wired or wireless network.

FIG. 4 is a flowchart for an example method 400 for reducing interference in a PLC network including a first node using a multi-carrier modulation communication standard operating at a first carrier frequency and a second carrier frequency and a second node using a single-carrier modulation communication standard based on a single-carrier frequency, according to an example embodiment. Step 401 comprises (i) determining non-overlapping transmission times for transmissions by the first node relative to second node transmission times on a shared PLC channel or (ii) selecting non-overlapping frequencies for the first carrier frequency and for a second carrier frequency which do not overlap with the single-carrier frequency or frequencies based on the single-carrier frequency on the shared PLC channel. Step 402 comprises transmitting from the second node using the single-carrier modulation communication standard at the second node transmission times. Step 403 comprises transmitting from the first node using the multi-carrier modulation communication standard at the non-overlapping transmission times or the non-overlapping frequencies. As noted above, in one embodiment the first communication standard can comprise OFDM modulation and the second communication standard can comprise FSK or BPSK modulation.

Many modifications and other embodiments of the invention will come to mind to one skilled in the art to which this Disclosure pertains having the benefit of the teachings presented in the foregoing descriptions, and the associated drawings. Therefore, it is to be understood that embodiments of the invention are not to be limited to the specific embodiments disclosed. Although specific terms are employed herein, they are used in a generic and descriptive sense only and not for purposes of limitation.

We claim:

1. A method for reducing interference on a shared powerline communications (PLC) channel in a PLC network including a first node using a multi-carrier modulation communication standard operating at a first carrier frequency and a second carrier frequency and a second node using a single-carrier modulation communication standard operating based on a single-carrier frequency, comprising:
on a shared PLC channel (i) determining non-overlapping transmission times for transmissions by said first node relative to second node transmission times for transmissions from said second node or (ii) selecting non-overlapping frequencies for said first carrier frequency and said second carrier frequency which do not overlap with said single-carrier frequency or frequencies based on said single-carrier frequency;
transmitting from said second node using said single-carrier modulation communication standard at said second node transmission times, and
transmitting from said first node using said multi-carrier modulation communication standard at said non-overlapping transmission times or said non-overlapping frequencies.

2. The method of claim 1, wherein said determining comprises:
performing an energy detection and analysis utilizing at least one energy threshold at said first node, and
if a presence of said single-carrier modulation is determined by said analysis, transmitting from said first node using said multi-carrier modulation communication standard only during said non-overlapping transmission times.

3. The method of claim 1, wherein said determining comprises:
performing an energy detection and analysis utilizing at least one energy threshold at said first node, and
if a presence of said single-carrier modulation is determined by said analysis, said first node utilizing a high pass filter, a low pass filter, a band pass filter, or a notch filter to minimize out of band emissions.

4. The method of claim 2, wherein said energy detection and analysis is provided by a plurality of blocks coupled in series to one another, said plurality of blocks comprising:
a fast Fourier transform (FFT) block and a tone selection block or a band pass filter;
an energy computation block, and
a threshold comparison block utilizing said energy threshold for determining a presence of a transmission of said single-carrier modulation communication standard on said shared PLC channel.

5. The method of claim 2, wherein said energy threshold is adaptively computed by estimating background noise energy in a frequency band corresponding to said transmitting using said single-carrier modulation communication standard.

6. The method of claim 2, wherein said energy threshold is pre-computed or is compiled over time and is dependent on a time of day.

7. The method of claim 1, wherein said selecting comprises using a sub-banding approach wherein sub-bands in symbols for said first communication standard at said first carrier frequency and said second carrier frequency do not overlap with said single-carrier frequency or said frequencies based on said single-carrier frequency.

8. The method of claim 1, wherein said multi-carrier modulation communication standard comprises Orthogonal Frequency-Division Multiplexing (OFDM) modulation and said single-carrier modulation standard comprises Frequency-shift keying (FSK) or binary phase shift keying (BPSK) modulation.

9. A modem for communications at a first node using a multi-carrier modulation communication standard including at first and second carrier frequencies on a shared powerline communications (PLC) channel in a PLC network including a second node using a single-carrier modulation communication standard at a single-carrier frequency, comprising:
a processor;
wherein said processor is coupled to a memory which stores a coexistence of communication standards algorithm, and wherein said processor is programmed to implement said coexistence of communication standards algorithm, said coexistence of communication standards algorithm:
performing (i) an energy detection and analysis utilizing at least one energy threshold to determine non-overlapping transmission times for transmissions by said first node relative to second node transmission times for transmissions by said second node on a shared PLC channel or (ii) frequency selecting at said first node to select said first carrier frequency and said second carrier frequency which do not overlap with said single-carrier frequency or frequencies based on said single-carrier frequency,
wherein said modem is configured for coupling to a PLC transceiver to provide said non-overlapping transmission times or said non-overlapping frequencies to said PLC transceiver so that said PLC transceiver transmits using said multi-carrier modulation communication standard at said non-overlapping transmission times or said non-overlapping frequencies.

10. The modem of claim 9, wherein said modem is formed on an integrated circuit (IC) comprising a substrate having a semiconductor surface, and wherein said processor comprises a digital signal processor (DSP).

11. The modem of claim 9, wherein said energy detection and analysis is provided by a plurality of blocks coupled in series to one another, said plurality of blocks comprising:
a fast Fourier transform (FFT) block and a tone selection block or a band pass filter;
an energy computation block, and
a threshold comparison block utilizing said energy threshold for determining a presence of a transmission of said single-carrier modulation communication standard on said shared PLC channel.

12. The modem of claim 9, wherein said energy threshold is adaptively computed by estimating background noise energy in a frequency band corresponding to said transmissions by said second node using said single-carrier modulation communication standard.

13. The modem of claim 9, wherein said energy threshold is pre-computed or is compiled over time and is dependent on a time of day.

14. The modem of claim 9, wherein said frequency selecting comprises using a sub-banding approach wherein sub-bands in symbols for said multi-carrier modulation communication standard at said first carrier frequency and said second carrier frequency do not overlap with said single-carrier frequency or said frequencies based on said single-carrier frequency.

15. The modem of claim 14, further comprising at least one tone mask corresponding to said single-carrier frequency or said frequencies based on said single-carrier frequency.

16. A communications device, comprising:
a memory which stores a coexistence of communication standards algorithm;
a modem for communications at a first node using a multi-carrier modulation communication standard including at first and second carrier frequencies on a shared powerline communications (PLC) channel in a PLC network including a second node using a single-carrier modulation communication standard at a single-carrier frequency, said modem comprising:
a processor coupled to said memory, wherein said processor is programmed to implement said coexistence of communication standards algorithm, said coexistence of communication standards algorithm:
performing (i) an energy detection and analysis utilizing at least one energy threshold to determine non-overlapping transmission times for transmissions by said first node relative to second node transmission times for transmissions by said second node on a shared PLC channel or (ii) frequency selecting at said first node to select said first carrier frequency and said second carrier frequency which do not overlap with said single-carrier frequency or frequencies based on said single-carrier frequency, and
a PLC transceiver communicably coupled to said modem for transmitting using said multi-carrier modulation communication standard at said non-overlapping transmission times or said non-overlapping frequencies.

17. The communications device of claim 16, wherein said modem is formed on an integrated circuit (IC) comprising a substrate having a semiconductor surface, and wherein said processor comprises a digital signal processor (DSP).

18. The communications device of claim 16, wherein said energy detection and analysis is provided by a plurality of blocks coupled in series to one another, said plurality of blocks comprising:
a fast Fourier transform (FFT) block and a tone selection block or a band pass filter;
an energy computation block, and
a threshold comparison block utilizing said energy threshold for determining a presence of a transmission of said single-carrier modulation communication standard on said shared PLC channel.

19. The communications device of claim 16, wherein said frequency selecting comprises using a sub-banding approach wherein sub-bands in symbols for said multi-carrier modulation communication standard at said first carrier frequency and said second carrier frequency do not overlap with said single-carrier frequency or said frequencies based on said single-carrier frequency.

20. The communications device of claim 19, wherein said processor implements at least one tone mask corresponding to said single-carrier frequency or said frequencies based on said single-carrier frequency.
